(19) United States
(12) Patent Application Publication
(10) Pub. No.: US 2009/0174217 A1
(43) Pub. Date: Jul. 9, 2009

(54) Integrated Shade Assembly for a Vehicle Window

(75) Inventors: Jennifer P. Lawall, Waterford, MI (US); Gregory J. Vargo, Troy, MI (US); Hans P. Lawall, Waterford, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/970,107

(22) Filed: Jan. 7, 2008

(51) Int. Cl. B60J 1/20

(52) U.S. Cl. 296/97.11

(57) ABSTRACT

A shade assembly for a vehicle is provided that includes a shade member that is “integrated” or “hidden” within vehicle body structure when not in use and yet is easily movable to a use position in which it covers a portion of an adjacent window. Specifically, a shade assembly is provided that includes vehicle body structure at least partially defining a body cavity. A shade member is operatively connected to the vehicle body structure and is configured to selectively move between a stowed position and a use position. The shade member at least partially covers a surface of the window in the use position. The window is substantially uncovered by the shade member in the stowed position because the shade member is nested in the cavity within the body structure.

### TECHNICAL FIELD

The invention relates to a vehicle shade assembly for a vehicle window. BACKGROUND OF THE INVENTION

Vehicles are often provided with sun visors for use by a driver and a front passenger. The visors fulfill a need for shading an occupant's eyes and are usually pivotably hinged to the headliner to allow selective shading of the front window or of a side window. Some vehicles, such as full-size vans, sometimes have shades that can be used to cover the side or rear window, providing shading and/or privacy for vehicle occupants. Current window shading systems are mounted to the vehicle so that they always occupy space in the passenger compartment even when not in use but in stored positions.

### SUMMARY OF THE INVENTION

A shade assembly for a vehicle is provided that includes a shade member that is “integrated” or “hidden” within vehicle body structure when not in use and yet is easily movable to a use position in which it covers a portion of an adjacent window. Specifically, a shade assembly is provided that includes vehicle body structure at least partially defining a body cavity. A shade member is operatively connected to the vehicle body structure and is configured to selectively move between a stowed position and a use position. The shade member at least partially covers a surface of the window in the use position. The window is substantially uncovered by the shade member in the stowed position because the shade member is nested in the cavity within the body structure.

The shade assembly may be a slide-type shade assembly in which guide tracks secured to the body structure are configured to guide the shade member between the stowed and the use positions. Alternatively, the shade assembly may be a roll-type shade assembly in which a roller mechanism secured to the body structure is operable to roll the shade member about the roller mechanism in the stowed position. Edge supports may be secured to opposing edges of the shade member to act as stiffeners, helping to ensure repeated accurate positioning of the shade member.

The body structure may be a roof and a headliner, a body pillar, such as an A-pillar, or a vehicle door. The shade assembly may be manual (i.e., pull-type) or may be powered by solar power or otherwise.

Thus, the shade assembly provides viewing comfort and privacy (in the case of opaque shade members) when desired for vehicle occupants without being obtrusive and occupying passenger compartment space when not in use (stowed), maximizing available headroom. Furthermore, the shade assembly is easy to use, requiring only a simple pull in the case of a manual assembly or the press of a switch for a power assembly. The shade member may be larger than a typical sun visor so that it is able to shade the entire windshield (either with one or two shade members) or the entire side glass for side glass embodiments. The shade member may be customized in different colors, even with a different interior side and exterior side color.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a first embodiment of a shade assembly;

FIG. 2A is a schematic plan view of a shade member used in the shade assembly of FIG. 1;

FIG. 2B is a schematic plan view of the other side of the shade member of FIGS. 1 and 2A;

FIG. 3 is a schematic perspective fragmentary view of a guide track guiding an edge support of the shade member of the shade assembly of FIG. 1;

FIG. 4 is a schematic perspective fragmentary view of an alternative guide track and edge support for the shade member of FIG. 1;

FIG. 5 is a schematic cross-sectional illustration of the shade member assembly of FIG. 1 taken at the arrows 5-5 in FIG. 1, illustrating the shade member in both a stowed position and a use position (shown in phantom);

FIG. 6 is a schematic cross-sectional illustration of a second embodiment of a shade assembly taken at the arrows 6-6 in FIG. 9;

FIG. 7 is a schematic perspective illustration of a third embodiment of a shade assembly;

FIG. 8 is a schematic side view illustration in fragmentary view of the shade assembly of FIG. 7;

FIG. 9 is a schematic perspective illustration of the shade assembly of FIG. 6;

FIG. 10 is a schematic perspective illustration of a fourth embodiment of a shade assembly;

FIG. 11 is a schematic plan view illustration of the shade assembly of FIG. 10;

FIG. 12 is a schematic perspective illustration of a fifth embodiment of a shade assembly;

FIG. 13 is a schematic cross-sectional illustration of the shade assembly of FIG. 12 taken at the arrows 13-13;

FIGS. 14A-14C are schematic perspective illustrations of an alternative shade member for use in the shade assembly of FIG. 7; and

FIG. 15 is a schematic perspective illustration of stacked guide tracks for guiding two different shade members.

### DESCRIPTION OF THE PREFERRED EMBODIMENTS

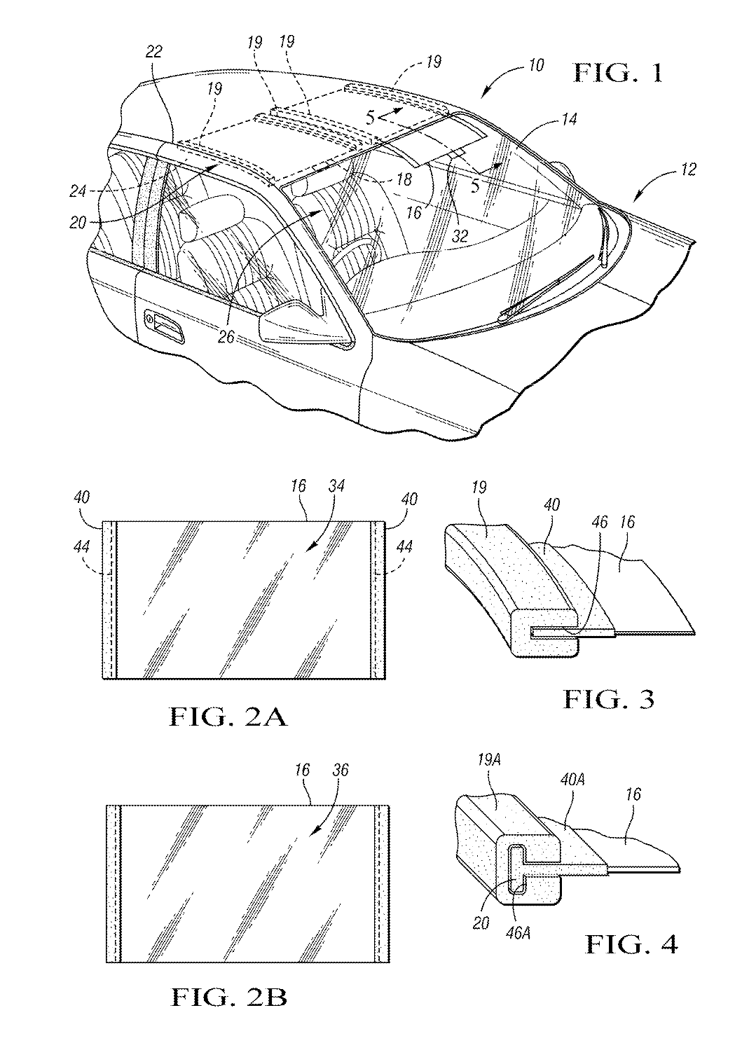

Referring to the drawings, wherein like reference numbers refer to like components, FIG. 1 illustrates a shade assembly 10 installed on a vehicle 12 to provide selective shade coverage for a front windshield 14. The shade assembly 10 is a slide-type shade assembly, with first and second shade members 16, 18 supported on guide tracks 19 that enable the shade members 16, 18 to selectively slide downward from a stowed position in which the shade members 16, 18 are nested inside of a cavity 20 defined by and between vehicle body structure, which in this embodiment is vehicle roof 22 and a headliner 24. The roof 22 may include an inner panel, an outer panel and various reinforcing members. The cavity 20 is inward of the innermost of such roof components.

Each of the shade members 16, 18 are selectively movable between a stowed position and a use position, either manually or by power, as described further herein. In FIG. 1, shade member 18 is in the stowed position and is hidden in the cavity 20 such that an inner surface 26 of a portion of the windshield 14 below the shade member 18 is substantially uncovered. The shade member 16 is shown in a use position such that a portion of the inner surface 26 of the windshield 14 adjacent the shade member 18 is covered by the shade member 18. The shade member 18 is only partially extended, and may be further extended to cover more of the inner surface 26, if desired. Alternatively, a pair of guide tracks 19 may be spaced to support a single shade member sized to selectively cover and uncover the entire width of the inner surface 26 of the windshield 14 in lieu of using two shade members 16, 18. The shade assembly 10 can be designed with shorter guide tracks if only partial shading of the windshield 14 is desired.

Referring to FIG. 5, the shade member 18 is shown in more detail, extending from the cavity 20 through a gap 30 defined between the vehicle roof 22 and the headliner 24. A pull tab 32 secured to a forward edge of the shade member 16 allows convenient manual sliding to the use position shown when the tab is pulled downward by a user. In the stowed position, only the tab 32 extends out of the cavity 20 through the gap 30. To return the shade member 16 to the stowed position, an upward and rearward manual force will cause the shade member 16 to slide rearward along the guide tracks 19.

Referring to FIG. 2A the shade member 16 is illustrated viewing a surface or first side 34 of the shade member 16 that faces away from the inner surface 26 of the windshield 14 when installed as in FIG. 1. The first side 34 may be either transparent or a solid, opaque color. As illustrated in FIG. 2B, an opposing surface or second side 36 of the shade member 16 that faces the inner surface 26 when installed as in FIG. 1 has a different color that may be selected to match the body color of the vehicle 12. Alternatively, the second side 36 may be transparent, may be the same color as the first side 34, may have, for example, a different texture, pattern or different graphics than the first side 34 or may have any other visual characteristic different than the first side. The shade member 16 is a thin film and may be any of a variety of materials, including Mylar, vinyl, nylon and polypropylene. The shade member 16 may be a single material panel as well.

As illustrated in FIGS. 2A and 2B, edge supports 40 that are secured to opposing sides 42, 44 of the shade member 16 to act as stiffening support members. As illustrated in FIG. 3, each guide track 19 has a slot 46 which stabilizes and secures the edge support 40 to permit sliding of the edge support 40 and shade member 16 relative to the guide track 19. The edge supports 40 keep the shade member 16 in close proximity to the windshield 14.

Referring to FIG. 4, an alternative edge support 40A is secured to the shade member 16. The edge support 40A has a T-shaped end 20 that is configured to fit within a T-shaped slot 46A in an alternative guide track 19A. The edge support 40A and guide track 19A may be used on any of the slide-type shade assemblies described herein.

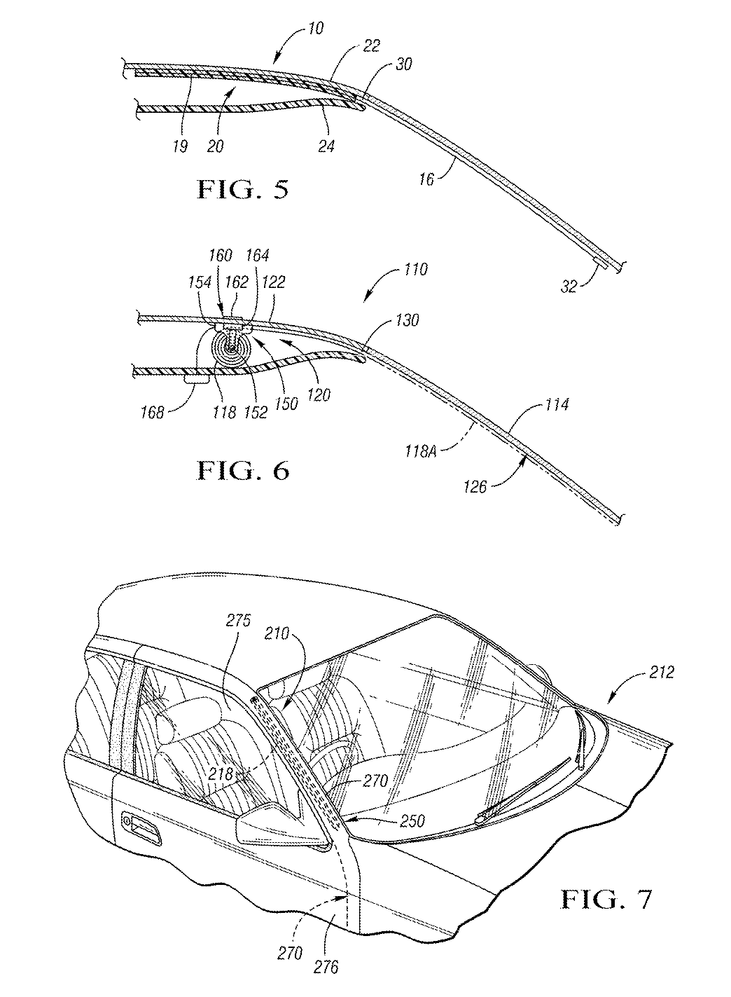

Referring to FIG. 6, another embodiment of a shade assembly 110 is shown. The shade assembly 110 is a roll-type shade assembly, and includes a roller mechanism 150 about which a shade member 118 is rolled in a stowed position. The roller mechanism 150 includes a simple roller 152 (shown in FIG. 9) and includes support mounts 154 supporting each end of the roller 152 and secured to vehicle roof 122. The shade member 118 is contained in a cavity 120 formed between the roof 122 and a headliner 124 when in the stowed position shown. The shade member 118 extends through the gap 130 formed between the roof 122 and the headliner 124 to at least partially cover an inner surface 126 of a windshield 114 when in an extended position (in which the portion of the shade member 118 extending beyond the stowed position is shown in phantom and is indicated as shade member 11 8A). Referring to FIG. 9, the shade assembly 110 includes a second shade member 116 supported on a roller mechanism identical to roller mechanism 150 for selectively covering and uncovering the portion of the windshield 114 adjacent the driver's side of the vehicle 112. Alternatively, a single, wider roller mechanism and shade member may be used to cover the entire width of the windshield 114 in place of the two roller mechanisms 152 and shade members 116, 118A of FIG. 9. Materials with static attraction to glass could be utilized to keep the shade member 118 in close proximity to the windshield 114.

Referring to FIG. 6, the roller mechanism 150 is powered via a power source which is a solar power module 160 that includes a solar panel 162 placed on the vehicle where it is able to absorb sunlight. The solar panel 162 is connected to a motor 164 and converts the light into electrical power that powers the motor 164. The motor 164 turns an end of the roller 152, through a gearing arrangement or otherwise. A switch 168 may be secured anywhere in the vehicle accessible to a user, here shown on the headliner 124, to turn the motor 164 off or on to allow selective raising and lowering of the shade member 118. If the switch 168 is pushed when the shade member 118 is in the stowed position, it will lower to the use position. If the switch 168 is pushed when the shade member 118 is in the use position it will raise to the stowed position. Alternatively, the switch 168 could be pushed a second time when the shade member 118 is moving between the stowed and use positions to stop the shade member 118 at a desired intermediate position. A subsequent push on the switch 168 would then return the shade member 118 to a stowed position (similar to a power window or a garage door). Another solar power module 160 and switch 168 may be provided for the shade member 116 of FIG. 9 as well. The switch 168 may be a three position switch, with (i) an off-position (in which the shade member 118 is not allowed to move from a current set position, and pushing the switch 168 will not result in movement of the shade member 118), (ii) a position which allows the shade member 118 to be activated during driving by pushing the switch 168, and (iii) a position which requires the motor 164 to automatically move the shade member 118 to the use position in response to a desired vehicle condition being met, such as the vehicle being in a park gear or being turned off. Additionally, the shade member 118 could be automatically actuated based on solar load on the solar panel 162. If the solar load causes actuation, the shade member 118 is moved down over the windshield 114 as a sun shield.

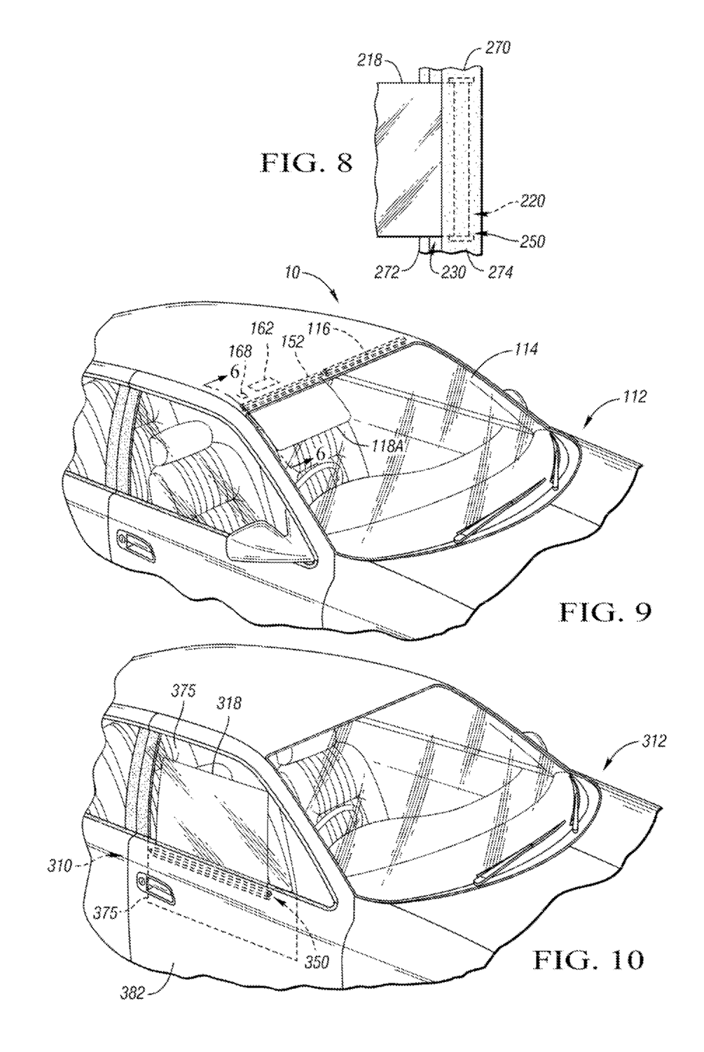

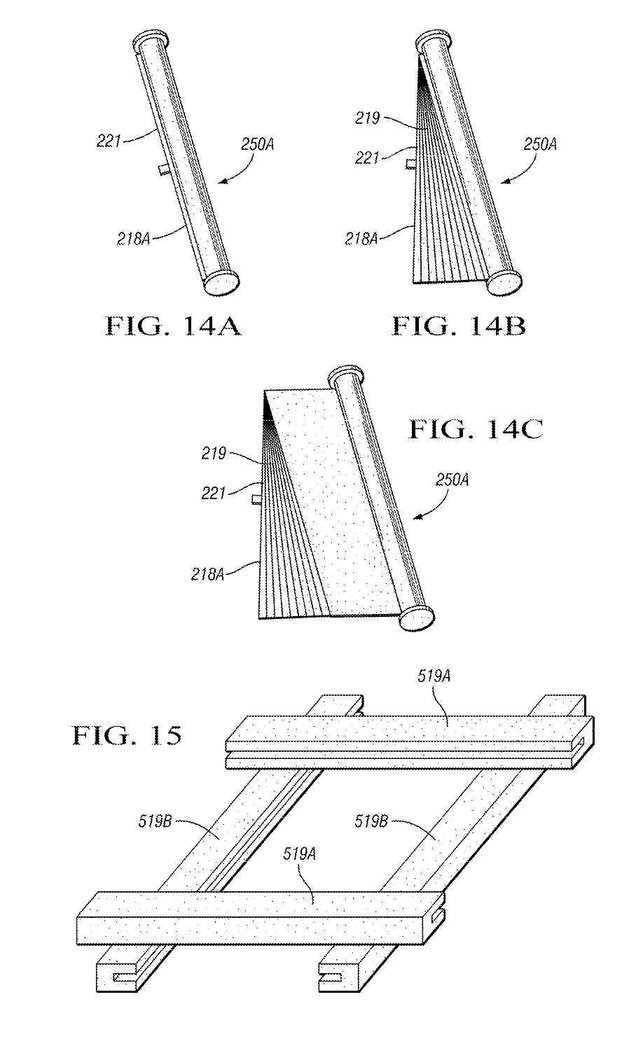

Referring to FIGS. 7 and 8, another embodiment of a shade assembly 210 is shown on a vehicle 212. The shade assembly 210 is a roll-type shade assembly utilizing a roller mechanism substantially identical to roller mechanism 150 shown and described with respect to FIGS. 6 and 9. However, the roller mechanism 250 of FIGS. 7 and 8 is secured to body structure in the form of an A-pillar 270 within a cavity 220 formed in the A-pillar 270, such as between an inner pillar portion 272 and outer panel pillar portion 274. The shade member 218 is contained within the cavity 220 when in the stowed position shown in FIG. 7, and selectively extends from the cavity 220 through a gap 230 formed between an outer pillar portion 274 and an inner pillar portion 272 of the A-pillar 270 to selectively cover an inner surface of the passenger side window 275 of FIG. 7. In FIG. 8, a passenger door 276 of FIG. 7 is removed to show the A-pillar 270. The roller mechanism 250 may be spring-loaded to store energy to aid in movement between the use and stowed positions. As illustrated in FIGS. 14A-14C, an alternative shade member 218A having a terminal portion 219 collapsible in a fan or accordion-like manner may be used. In FIG. 14A, the shade member 218A is in a stowed position within roller mechanism 250A, with the terminal portion 219 folded back via any memory-like feature, such as elastic, so that the a forward edge 221 of the shade member 218A is parallel with the roller mechanism 250 and a body pillar in which the roller mechanism 250 is stored, such as A-pillar 270. In FIG. 14B, the shade member 218A is partially extended and in FIG. 14C further extended, with the forward edge 221 nonparallel with roller mechanism 250 and a body pillar in which the roller mechanism 250 is stored, such as A-pillar 270. The terminal portion 219 of the shade member 218A can be configured to conform to various A-pillar angles of different vehicles.

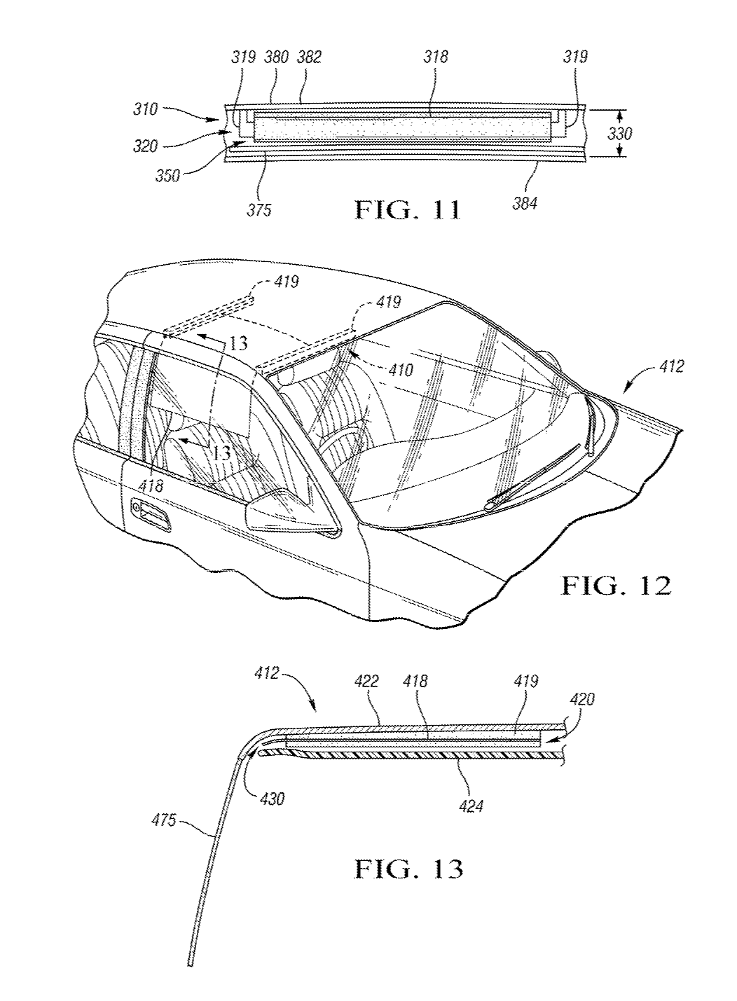

Referring to FIGS. 10 and 11, another embodiment of a shade assembly 310 is illustrated on a vehicle 312. The shade assembly 310 is a roller-type shade assembly having a roller mechanism 350 substantially identical to roller mechanism 150 shown and described with respect to FIG. 6, except that the roller mechanism 350 is secured via end mounts 319 to an inner door panel 380 of a vehicle door 382. The vehicle door 382 also has an outer door panel 384 that forms with the inner door panel 380 a door cavity 320. A gap 330 formed by the inner and outer door panels 380, 384 at the upper end of the cavity 320 permits the shade member 318 to selectively extend therethrough, as shown in FIG. 10, to cover an inner surface of the passenger window 375.

Referring to FIGS. 12 and 13, another embodiment of a shade assembly 410 is illustrated on a vehicle 412. The shade assembly 410 is a slide-type shade assembly for a side window 475. The shade assembly 410 includes a shade member 418 that is slideably supported on guide tracks 419 secured to a vehicle roof 422. The guide tracks 419 and shade member 418 are nested within a cavity 420 formed between roof 422 and a headliner 424. The shade member 418 is substantially within the cavity 420 when in a stowed position shown in FIG. 13. The shade member 418 extends from the cavity 420 through a gap 430 when in a use position shown in FIG. 12, in which at least some of the inner surface of the window 475 is covered. The shade member 418 may be manual, or powered by any motor, including a solar-powered motor as described with respect to the embodiment of FIG. 6. In another embodiment, guide tracks for a slide-type shade assembly for a side window may be stacked with guide tracks for a slide-type shade assembly for a front windshield, as illustrated in FIG. 15, as a dual track system. In FIG. 15, upper guide tracks 519A are positioned to slidably support a shade member (not shown, but such as shade member 418 of FIG. 12) that slides out of the end of the guide tracks (right end as shown in FIG. 15) to cover a side window. The lower guide tracks 519B slidable support another shade member (not shown, but such as shade member 18 of FIG. 1) that slides out of the ends of the tracks 519B (front ends of the tracks 519B as shown in FIG. 15) to cover a windshield. Accordingly, as viewed in FIG. 15, the stacked guide tracks 519A, 519B are positioned for use on a driver's side window and a front windshield, if nested between roof structure and a headliner as are the other slide-type shade assemblies of FIGS. 1-4 and 11-13. The guide tracks 519A, 519B can be mechanically attached (e.g., riveted or with fasteners) or plastically welded to one another to form an integrated assembly.

While the best modes for carrying out the invention have been described in detail, those familiar with the art to which this invention relates will recognize various alternative designs and embodiments for practicing the invention within the scope of the appended claims.

1. A shade assembly for a vehicle having a window comprising:
vehicle body structure at least partially defining a body cavity;
a shade member operatively connected to the vehicle body structure and configured to selectively move between a stowed position and a use position; wherein the shade member at least partially covers a surface of the window in the use position; wherein the surface of the window is substantially uncovered by the shade member and the shade member is substantially nested in the cavity within the vehicle body structure when the shade member is in the stowed position;
at least one guide track secured to the vehicle body structure adjacent the window; wherein the at least one guide track is configured to guide the shade member between the stowed and use positions;
wherein the shade member is a first shade member; and wherein the at least one guide track includes a first pair of aligned guide tracks configured to guide the first shade member and a second pair of aligned guide tracks stacked on the first pair of aligned guide tracks for supporting a second shade member.

2. The shade assembly of claim 1, wherein the first shade member is one of Mylar, vinyl, nylon, and polypropylene.

3. The shade assembly of claim 1, wherein the first shade member is a single panel of material.

4. The shade assembly of claim 1, wherein the first shade member has a first side facing the window and a second side facing away from the window; and wherein the first side differs in appearance from the second side by at least one visual characteristic.

5-6. (canceled)

7. The shade assembly of claim 10, wherein the at least one edge support is substantially T-shaped; and wherein the at least one of the first pair of aligned guide tracks has a substantially T-shaped slot in which the at least one edge support slides.

8. The shade assembly of claim 1, wherein the vehicle body structure includes a roof and a headliner which together at least partially define the cavity and define a gap; wherein the at least one guide track is secured to one of the roof and the headliner and nested in the cavity between the roof and the headliner such that the shade members are between the roof and the headliner in the stowed position and extend through the gap in the use position.

9. (canceled)

10. The shade assembly of claim 1, wherein the first shade member has opposing edges, and further comprising:
at least one edge support secured to at least one of the opposing edges and configured to stiffen the first shade member; wherein the at least one edge support is cooperatively configured to slide within the first pair of aligned guide tracks.

11. A shade assembly for a vehicle having a window comprising:
a frame pillar adjacent the window and defining a cavity within the frame pillar and a gap;
a shade member operatively connected to the frame pillar and configured to selectively move between a stowed position and a use position; wherein the shade member at least partially covers a surface of the window in the use position; wherein the surface of the window is substantially uncovered by the shade member in the stowed position;
a roller mechanism secured to the frame pillar within the cavity and secured to the shade member such that the shade member is within the cavity in the stowed position and extends through the gap in the use position; and wherein the roller mechanism is operable to roll the shade member about the roller mechanism in the stowed position;
wherein the shade member includes a collapsible terminal portion configured so that opposing edges of the shade member are substantially the same length when the terminal portion is collapsed and are different lengths when the terminal portion is extended, the opposing edges remaining substantially parallel with one another whether the terminal portion is collapsed or extended; and
wherein a forward edge of the shade member is not parallel with the roller mechanism and not perpendicular to the opposing edges when the terminal portion is extended, and is substantially parallel with the roller mechanism and substantially perpendicular to the opposing edges when the terminal portion is collapsed.

12-15. (canceled)

16. The shade assembly of claim 1, further comprising:
a power source operatively connected to the shade members and controllable to selectively power the shade member to move between the stowed position and the use position.

17. The shade assembly of claim 16, wherein the power source is a solar power module.

18. The shade assembly of claim 16, further comprising:
a control switch operatively connected to the power source and selectively movable to direct power from the power source to the shade members.

19. A shade assembly for a vehicle having a window comprising:
vehicle body structure;
a shade member operatively connected to the vehicle body structure and configured to selectively move between a stowed position and a use position;
a roller mechanism secured to the vehicle body structure within the cavity and secured to the shade member; wherein the roller mechanism is operable to roll the shade member about the roller mechanism in the stowed position;
wherein the shade member includes a collapsible terminal portion configured so that opposing edges of the shade member are substantially the same length when the terminal portion is collapsed and are different lengths when the terminal portion is extended, the opposing edges remaining substantially parallel with one another whether the terminal portion is collapsed or extended;
wherein a forward edge of the shade member is not parallel with the roller mechanism and not perpendicular to the opposing edges when the terminal portion is extended, and is substantially parallel with the roller mechanism and substantially perpendicular to the opposing edges when the terminal portion is collapsed;
wherein the shade member at least partially covers a surface of the window in the use position and wherein the surface of the window is substantially uncovered by the shade member when the shade member is in the stowed position.

20. (canceled)
